(19) United States
(12) Patent Application Publication
(10) Pub. No.: US 2026/0309324 A1
(43) Pub. Date: Oct. 8, 2026

(54) APPARATUS FOR FEEDING SOLID FUEL FEEDSTOCK INTO A FURNACE

(71) Applicant: British American Tobacco (Investments) Limited, London (GB)

(72) Inventors: Jeronimo SCREMIN, Rio de Janeiro (BR); Renan ROSSA, Estância Velha (BR)

(21) Appl. No.: 19/485,111

(22) PCT Filed: May 17, 2024
(86) PCT No.: PCT/EP2024/063761

§ 371 Date: Nov. 17, 2025

(30) Foreign Application Priority Data
May 19, 2023 (BR) 1020230097057
May 19, 2023 (GB) 2307530.2

(51) Int. Cl. F23B 40/00; A24B 1/02; F23K 3/16; F23N 1/00; F26B 3/04

(52) U.S. Cl. CPC F23B 40/00; A24B 1/02; F23K 3/16; F23N 1/005; F23K 2203/20; F26B 3/04; F26B 2200/22

(57) ABSTRACT

An apparatus for feeding solid fuel feedstock into a furnace is described. The apparatus comprises a conveyor arranged to convey feedstock to a feed zone, a drive assembly arranged to drive the conveyor, and a feed member. The feed member is arranged to move between a hold position in which feedstock is held in the feed zone, and a feed position in which the feed member is configured to feed feedstock to the furnace. The drive assembly is arranged to synchronously operate the feed member and the conveyor. A furnace system comprising the apparatus and a furnace is also described. A method of delivering solid fuel feedstock into a furnace is also described.

### CROSS-REFERENCE TO RELATED APPLICATIONS

This present application is a National Phase entry of PCT Application No. PCT/EP2024/063761, filed May 17, 2024, which claims priority from Brazil Application No. 1020230097057, filed May 19, 2023, and which claims priority from Great Britain Application No. 2307530.2, filed May 19,2023, each of which are fully incorporated herein by reference in their entireties.

### TECHNICAL FIELD

The present invention relates to an apparatus and method for feeding solid feedstock into a furnace. The present invention also relates to a system comprising an apparatus and a furnace.

### BACKGROUND

Tobacco is an agricultural crop of considerable economic importance, used primarily in the manufacture of cigarettes, cigars, and other such products. Tobacco is grown in more than one hundred (mostly tropical) countries, spread across North and South America, Europe, Africa and Asia, including, for example, Brazil, Italy, Turkey, Pakistan, USA and Tanzania. There are various types (varieties) of tobacco, the three most common types being Virginia, grown frequently in countries like Brazil, China, India, Tanzania and the US; Burley, grown frequently in countries like Brazil, Italy and the US; and Oriental, grown frequently in countries like Greece and Turkey. Cigarettes may be produced containing just one variety of tobacco, e.g. Virginia, or blends of multiple varieties of tobacco.

The post-harvest processing of tobacco leaves typically includes drying (curing) the leaves and removing (separating or defoliating) the leaves from the tobacco plants prior to use in cigarettes. The curing process is performed not only to remove moisture from (dehydrate) the tobacco leaves, but also to achieve desired attributes of sensorial quality due to chemical changes in the tobacco leaves. Virginia tobacco is usually cured in heated barns (so is sometimes referred to as “flue-cured” tobacco).

The consumer experience of tobacco typically occurs through smoking a cigarette or cigar, and is characterised by various sensory inputs relating to flavour, taste, aroma, etc. Cigarette manufacturers seek to provide consumers with a consistent and reliable product, including in terms of the various sensory factors mentioned above. However, given that tobacco is a natural product, it may be subject to intrinsic variation between individual plants, combined with additional variations such as differences in growing location, soil and/or details of subsequent processing for the tobacco (such as curing).

The tobacco curing process requires temperature and humidity variation over time to provide controlled water extraction. The process occurs in curing chambers called tobacco barns. Air is heated by the furnace and continuously circulated between the tobacco leaves in the curing chamber to cure the tobacco. Curing cycles can take around 140 hours and in this time the furnace must be fed regularly to provide consistent heat output. Firewood is frequently used as a fuelstock for the furnace. Due to the length of the curing cycles, the furnaces require constant fuel replenishment. The furnace is fed manually, and the fuel is heavy and bulky.

### SUMMARY

In accordance with some embodiments described herein, there is provided an apparatus for feeding solid fuel feedstock into a furnace comprising a conveyor arranged to convey feedstock to a feed zone, a drive assembly arranged to drive the conveyor, and a feed member arranged to move between a hold position in which feedstock is held in the feed zone, and a feed position in which the feed member is configured to feed feedstock to the furnace; wherein the drive assembly is arranged to synchronously operate the feed member and the conveyor.

When the drive assembly is driven, the drive assembly may be configured to move the conveyor continuously.

When the drive assembly is driven, the drive assembly may be configured to move the feed member periodically between the hold position and the feed position.

The drive assembly may comprise a drive member configured to drive the conveyor.

The drive member may be configured to directly drive the conveyor. The drive member may be a shaft.

The drive assembly may comprise a motor arranged to drive the shaft.

The conveyor may comprise conveyor elements configured to act on feedstock elements of feedstock.

The conveyor may comprise a conveyor belt. The conveyor belt may comprise a chain. The conveyor belt may be driven by the shaft.

The drive assembly may comprise a feed member actuating assembly arranged to actuate the feed member.

The drive assembly may comprise a mechanical linkage arranged to actuate the feed member between the hold position and feed position.

The mechanical linkage may be driven by the drive member. The mechanical linkage may comprise a cam arrangement.

The cam arrangement may be arranged to actuate the feed member from the hold position to the feed position.

The feed member may be biased towards the hold position. The feed member may be pivotally mounted.

The cam arrangement may comprise a cam to bias the feed member into the hold position.

The apparatus may comprise a return assembly to bias the feed member into the hold position.

The return assembly may act on the feed member throughout its positions.

The return assembly may comprise a counterweight configured to bias the feed member towards the hold position.

The feed member may be arranged to act as a barrier. The feed member may be arranged to support feedstock in the hold position. The feed member may be arranged to guide feedstock movement in the feed position.

The feed member may be arranged to cover a feed opening of a furnace. The feed member may comprise a sealing arrangement arranged to seal around a feed opening in the furnace.

The sealing arrangement may be a thermal seal. The sealing arrangement may be a gaseous seal.

The apparatus may comprise a guide member in the feed zone to retain feedstock in the hold position.

The apparatus may comprise a feed chute arranged to provide a path from the feed zone to the feed opening.

The feed chute may provide an enclosed channel between the feed member and the feed opening.

The apparatus may comprise a feedstock store. The conveyor may be arranged to convey feedstock from the feedstock store to the feed zone. The feed zone may be located above feedstock store during operation. The conveyor may be arranged to convey feedstock on an incline. The feedstock store may be arranged to provide a supply of feedstock to the conveyor.

The apparatus may comprise a controller arranged to operate the drive assembly.

The apparatus may comprise a temperature sensor. The temperature sensor may be configured to detect the furnace temperature.

The apparatus may comprise a temperature sensor configured to detect an atmospheric temperature.

The apparatus may comprise a temperature sensor configured to detect an atmospheric temperature of a space. The space may be a drying chamber. The drying chamber may be a drying barn.

The controller may be configured to actuate the drive assembly in dependence on the detected temperature received from the temperature sensor.

The controller may comprise a processor and a memory, wherein the temperature sensor is configured to send the detected temperature to the processor, and wherein the processor is configured to compare the detected temperature to a threshold value stored by the memory, and to operate the drive assembly in dependence on the comparison between the detected temperature and the threshold value.

The processor may be configured to operate the drive assembly in dependence on the detected temperature being lower than the threshold value.

The controller may be configured to actuate the drive assembly on receipt of an electrical signal from the temperature sensor, in dependence on the electrical signal indicating a value lower than a threshold value.

The electrical signal may be a first electrical signal and the threshold value may be a first threshold value, and the controller is configured to stop actuation of the drive assembly on receipt of a second electrical signal from the temperature sensor, in dependence on the second electrical signal indicating a value higher than a second threshold value.

In accordance with some embodiments described herein, there is provided a furnace system comprising the apparatus previously described, and a furnace.

The furnace may comprise a feed opening. The furnace may comprise a major axis, the feed opening disposed perpendicular to the major axis.

The furnace may comprise a substantially cylindrical sidewall along the major axis. The feed opening may be disposed in the cylindrical sidewall. The feed zone may be arranged above the feed opening such that feedstock is fed into the furnace through the feed opening.

In the hold position, the feed opening may be at least substantially obscured, preventing feedstock from entering the furnace. In the feed position, the feed opening may be at least partially exposed to allow feedstock to enter the furnace.

In use, feedstock may be transported to the feed zone by the conveyor and the feed member may be moved to the open position to move the feedstock from the feed zone into the feed opening.

The feed opening may be a first opening and the furnace may comprise a second opening along the major axis of the furnace. The second opening may be at an end wall of the furnace.

In accordance with some embodiments described herein, there is provided a method of delivering solid fuel feedstock into a furnace comprising conveying feedstock to a feed zone, providing a feed member in a hold position in which feedstock is held in the feed zone, and activating the feed member to move from the hold position to a feed position to feed the feedstock into the furnace; wherein the conveying and activation are synchronously driven by a drive assembly.

The conveying may occur continuously when the drive assembly is driven. The activation of the feed member may occur periodically when the drive assembly is driven.

The method may comprise loading the feedstock onto the conveyor from a feed store.

The method may comprise activating, by means of a controller, the drive assembly to drive the conveyor and feed member. The method may comprise detecting, by means of a sensor, the temperature in the furnace. The method may comprise activating the controller based on an input from the sensor.

### BRIEF DESCRIPTION OF THE DRAWINGS

Embodiments of the invention will now be described, by way of example only, with reference to accompanying drawings, in which:

FIG. 1 shows a perspective view of an apparatus for feeding solid fuel feedstock into a furnace;

FIG. 2 shows a further perspective view of the apparatus of FIG. 1;

FIG. 3a shows a side view of the apparatus of FIG. 1;

FIG. 3b shows a detail view of the drive assembly of the apparatus of FIG. 1; and

FIG. 4 is a schematic view of a controller system of the apparatus of FIG. 1.

### DETAILED DESCRIPTION

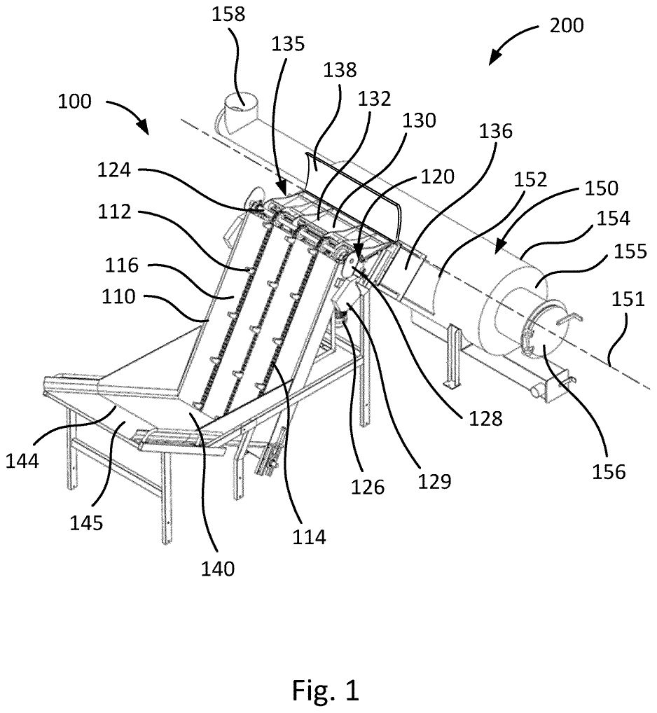

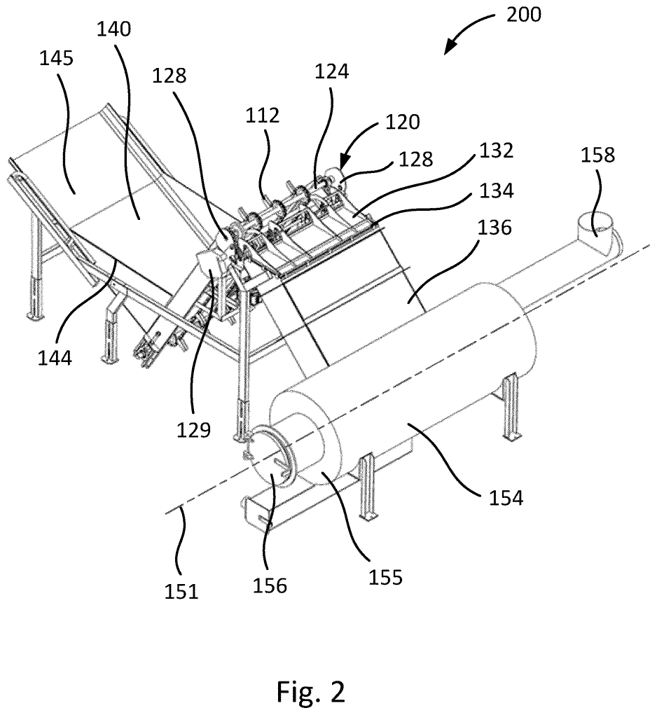

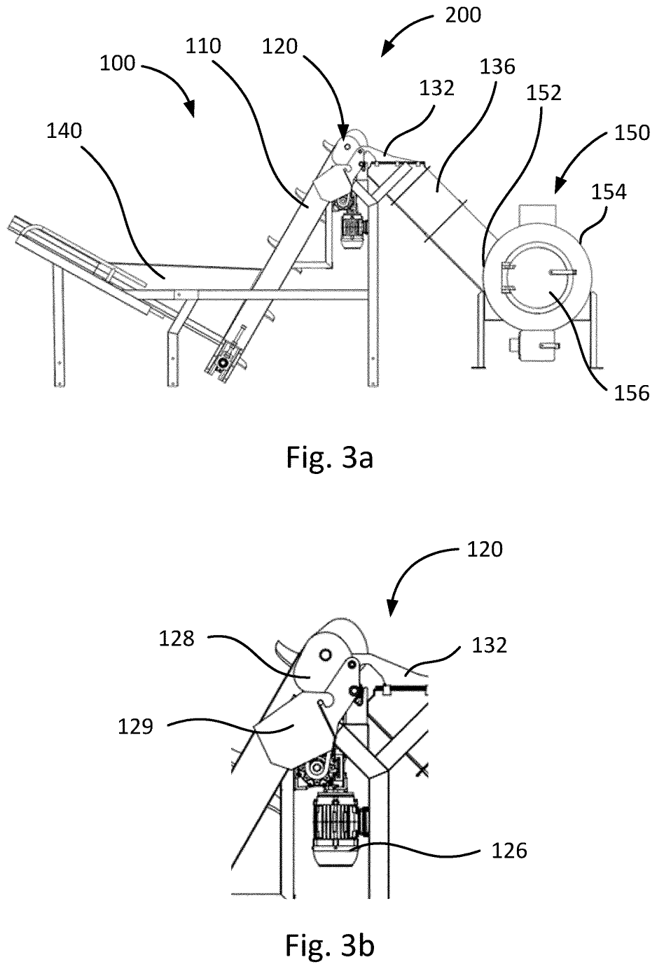

FIG. 1 shows the furnace system 200 comprising a feed apparatus 100 and furnace 150. FIGS. 2 and 3a also show the furnace system 200. The apparatus 100 comprises a conveyor 110, a drive assembly 120 and a feed member 130.

The conveyor 110 conveys feedstock from a feedstock store 140 to a feed zone 135. The feed member 130 is arranged to move between a hold position and a feed position. In the hold position, the feed member 130 holds the feedstock in the feed zone 135. In the feed position, the feed member 130 allows feedstock to be fed into the furnace 150. The feed member 130 guides feedstock to the furnace. The apparatus 100 is connected to the furnace 150 such that the apparatus transports feedstock from the feedstock store 140 to the furnace 150.

The feed member 130 comprises a barrier 132. The barrier 132 prevents the feedstock from entering the furnace 150 in the hold position. In the feed position, the barrier 132 permits movement of the feedstock into the furnace 150.

Stock of feedstock is preloaded into the store 140. Capacity of the store 140 is dependent on the desired operational capacity of the feed apparatus 100. The size of the store 140 may be configured to operating parameters of the furnace. If desired, additional feedstock is loaded into the store 140 during operation of the furnace system 200.

Solid fuel feedstock for the furnace 150 is held in the feedstock store 140. The feedstock store 140 comprises a feedstock receptacle 144. The feedstock receptacle 144 comprises side walls to retain the feedstock in the receptacle 144 before being conveyed by the conveyor 110. The feedstock receptacle 144 comprises an inclined surface 145 on which the feedstock is received and held in the receptacle 144. The inclined surface 145 is inclined downwardly towards the conveyor 110 such that the feedstock is held close to the conveyor 110 such that the conveyor 110 can convey the feedstock to the feed zone 135. The inclined surface 145 feeds feedstock to the conveyor automatically using gravity. In use, the user supplies batches of feedstock to the receptacle 144 such that the feedstock is held in the feedstock store 140 before being conveyed to the feed zone 135. The feeding of the conveyor 110 by the receptacle 144 is gravity assisted. In use, the receptacle 144 can be fed with feedstock by the operator. The receptacle 144 may hold enough feedstock for several hours of furnace operation.

The feedstock comprises wood such as logs or manufactured wood fuel. The feedstock may be pre-cut to a defined length. The width of the conveyor is greater than the length of the feedstock. The use of the conveyer enables feedstock of varying size to be accommodated.

The conveyor 110 conveys feedstock from the feedstock store 140 to the feed zone 135. The conveyor 110 comprises a chain 114. The conveyor 110 may comprise a belt. The conveyor comprises conveyor elements 112 on the chain 114 which act on the feedstock to retain it on the conveyor 110. The conveyor elements 112 may comprise protrusions or teeth in the chain 114 by which the feedstock is held during conveying. The conveyor 110 is on an incline such that the feedstock is raised by the conveyor 110 from the feedstock store 140 to the feed zone 135. The conveyor 110 comprises a back plate 116 to support the feedstock being conveyed to the feed zone 135. The feedstock may comprise firewood or wood fuel. The conveyor 110 and protrusions on the chain may be dimensioned to correspond to the dimensions of the firewood. The protrusions may allow the conveying of feedstock of difference sizes. The conveyor can convey feedstock of varying sizes. The conveyor can convey many pieces or units of feedstock per unit of time. One or more pieces or units of feedstock can be positioned between the protrusions.

The conveyor 110 is driven by the drive assembly 120. The drive assembly is arranged to synchronously operate the feed member 130 and the conveyor 110. The drive assembly 120 comprises a drive member 124. The drive member drives the conveyor 110. The drive member comprises a shaft 124. The drive assembly 120 comprises a motor 126. The motor 126 is arranged to drive the drive member 124. The conveyor 110 is connected to and driven by the shaft 124. The shaft 124 directly drives the conveyor 110. Pulleys or gears may be attached to the shaft 124 to interact with the chain 114 or belt to drive the conveyor 110. The shaft 124 may comprise a drive pulley or drive gear connected to the motor 126. The drive assembly 120 is configured to move the conveyor 110 continuously when the drive assembly 120 is being driven by the motor 126.

FIG. 3b shows a detail view of the drive assembly 120. The drive assembly 120 comprises a feed member actuating assembly which actuates the feed member 130. The feed member actuating assembly comprises a mechanical linkage. The mechanical linkage is driven by the drive member 130. The mechanical linkage comprises a cam arrangement 128. The cam arrangement 128 is mounted on the shaft 124 and therefore driven by the motor 126. Rotation of the shaft 124 drives the conveyor 110 and the cam arrangement 128. The cam arrangement 128 acts on a portion of the feed member 130 to move the barrier 132 between a hold position and a feed position. The cam arrangement 128 acts on feed member 130 to periodically actuate the barrier 132 between the hold position and the feed position when the shaft 124 is driven by the motor 126. The feed member 130 is pivotally mounted on the apparatus 100 such that is pivots between the hold position and the feed position. The shaft 124 rotates to continuously drive the conveyor 110 when the motor 126 is driven. The cam arrangement 128 rotates to periodically act on the feed member 130 to move the barrier 132 from the hold position to the feed position.

In the hold position, a feed opening 152 in the furnace 150 is at least substantially obscured by the barrier 132, preventing feedstock from entering the furnace 150. In the feed position, the feed opening 152 is at least partially exposed by movement of the barrier 132 to allow feedstock to enter the furnace 150. The barrier 132 is biased towards the hold position. FIGS. 1 to 3 show the barrier 132 in the hold position. The cam arrangement 128 acts on a portion of the feed member 130 to pivot the barrier 132 into the feed position. The drive assembly 120 comprises a counterweight 129 mounted on the cam arrangement 128. The counterweight 129 acts on the feed member 130 to bias the barrier 132 into the hold position. The cam of the cam arrangement 128 urges the barrier 132 into the feed position. The counterweight 129 urges the barrier 132 into the hold position. The cam and the counterweight 129 act at different times. The counterweight 129 acts throughout the range of motion, and causes the barrier 132 to move towards the hold position when the cam is not urging the barrier 132 into the hold position.

The feed zone 135 is defined between the top of the conveyor 110 and the barrier 132 when the barrier is in the hold position. The barrier 132 supports feedstock in the hold position. The feedstock is conveyed to the feed zone 135 and retained by the barrier 132. A predetermined volume of feedstock may be retained in the feed zone. A guide member 138 (shown in FIG. 1) is present to further retain the feedstock in the hold position. The guide member 138 also guides the feedstock into the feed opening 152 when the barrier 132 is moved to the feed position. The feed zone 135 is arranged above the feedstock store 140 such that the feedstock is conveyed up to the feed zone 135. The furnace 150 is arranged below the feed zone 135.

The furnace 150 is substantially cylindrical, although other configurations are anticipated. The furnace 150 has a major axis 151 disposed axially along the centre of the cylindrical furnace 150. The feed opening 152 is disposed perpendicular to the major axis 151. The furnace 150 comprises a cylindrical sidewall 154 along the major axis 151. The feed opening 152 is disposed in the cylindrical sidewall 154. Feedstock is fed into the furnace 150 laterally to the major axis 151. Feedstock is fed into the furnace 150 through the feed opening 152 perpendicular to the major axis 151.

The feed opening 152 is a first opening in the furnace 150, and a second opening 156 is present at an end of the furnace 150. The second opening 156 is disposed on the major axis 151 of the furnace 150. The second opening 156 is at an end wall 155 of the furnace 150. The furnace comprises a chimney or outlet 158 to allow smoke to exit the furnace 150. The apparatus 100 comprises a feed chute 136 disposed between the feed zone 135 and the feed opening 152. The feed chute 136 is attached to the furnace at the feed opening 152. The feed chute 136 provides a path for the feedstock between the feed zone 135 and the feed opening 152. The feed chute 136 provides an enclosed channel between the barrier 132 and the feed opening 152. When the barrier 132 is moved to the feed position, the feedstock is fed into the furnace 150 through the feed opening 152 by the feed chute 136.

The feed member 130 comprises a sealing arrangement 134 arranged to seal around the feed opening 152. The sealing arrangement 134 comprises a sealing element 134. The sealing element 134 seals around the feed chute 136. The sealing element 134 seals between the feed chute 136 and the barrier 132 in the hold position. The sealing element 134 may be disposed around the edge of the feed chute 136. In the feed position, the barrier 132 is moved away from the sealing element 134. In embodiments, the sealing arrangement may be a thermal seal. The sealing arrangement may be a gaseous seal. The seal may prevent smoke and/or heat from escaping from the feed chute when the barrier 132 is in the hold position.

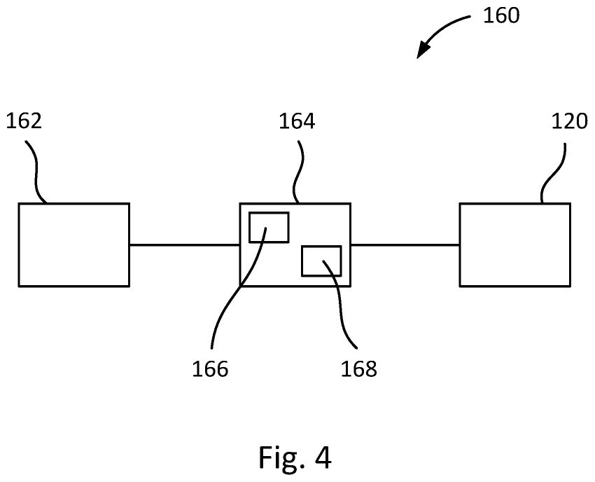

As shown in FIG. 4, the apparatus 100 comprises a controller system 160 comprising a controller 164 arranged to operate the drive assembly 120. The apparatus 100 comprises a temperature sensor 162 to detect the temperature in the furnace 150. The controller 164 actuates the drive assembly 120 when the temperature detected in the furnace 150 by the sensor 162 is below a preset threshold. The sensor 162 measures the furnace temperature at set intervals. The controller 164 receives electrical signals from the sensor 162. If the temperature is above the preset threshold, no action is taken. If the temperature is below the threshold, the controller 164 actuates the drive assembly 120. After actuation of the drive assembly 120, the sensor 162 continues to monitor the furnace temperature at intervals, but the controller 164 does not activate the drive assembly 120 to allow the furnace 150 to heat up after the feedstock is fed into the furnace 150 until a preset heat-up period is completed. After this preset heat-up period is over, the controller 164 allows activation of the drive assembly 120 if the temperature is below the threshold. In embodiments, controller 164 may not determine the temperature of the furnace 150 during the heat-up period.

The controller 164 comprises a processor 166 and a memory 168. The processor 166 receives the temperature detected by the sensor 162, and compares the detected temperature to a threshold value stored by the memory 168. The drive assembly 120 is operated in dependence on the comparison between the detected temperature and the threshold value. If the furnace temperature is below the threshold value, the controller 164 operates the drive assembly 120 to actuate the conveyor 110 and feed member 130 such that feedstock is delivered to the furnace 150. The controller 164 activates the motor 126 which drives the shaft 124 to synchronously actuate the conveyor 110 and the feed member 130. The conveyor 110 is continuously driven while the barrier 132 is periodically moved between the hold position and the feed position. In embodiments, the controller 164 may continue to operate the drive assembly 120 in response to a first electrical signal from the sensor 162 indicating that the furnace temperature is below the threshold value. The controller 164 will stop operating the drive assembly 120, when a second electrical signal is received from the sensor 162 indicating that the furnace temperature is at or above the threshold value.

The process of delivering feedstock from the feedstock store 140 to the furnace 150 comprises: loading the feedstock onto the conveyor 110 from a feed store 140, detecting, by means of a sensor 162, the temperature in the furnace 150; activating the controller 164 based on an input from the sensor 162; activating the drive assembly 120 to drive the conveyor 110 and feed member 130, conveying the feedstock to a feed zone 135; providing a feed member 130 in a hold position in which the feedstock is held in the feed zone 135; and activating the feed member 130 to move from the hold position to a feed position to feed the feedstock into the furnace 150.

The automated feeding process allows for the user to load the feedstock store 140 with enough feedstock to last for several hours. The user is not required to manually load feedstock into the furnace 150. The user does not have to constantly monitor the furnace operating conditions in order to feed feedstock to the furnace.

The apparatus 100 may be located in a drying barn in which the tobacco or other such products are dried. The tobacco is dried by air the air in the barn. The air in the drying barn is heated by the furnace. The drying barn defines one or more drying chambers.

The apparatus in embodiments comprises a temperature sensor configured to detect an atmospheric temperature of a space, such as a drying barn.

The apparatus may comprise a temperature sensor configured to detect an atmospheric temperature of a space. The barn may comprise one or more external sensors to measure the temperature of the air outside of the furnace. This allows the air in the barn to be maintained at a substantially constant temperature for improved drying conditions. The external temperature sensor sends electrical signals to the controller 164 to actuate the drive assembly. The temperature sensor may send a first electrical signal which activates the drive assembly 120. The controller 164 may continue to actuate the drive assembly 120 until a second electrical signal is received from the temperature sensor in the barn, indicating that the barn air temperature has reached a barn threshold value. The controller 164 stops actuation of the drive assembly 120 when the second electrical signal is received from the external sensor.

The external temperature sensor may be used in conjunction with, or as an alternative to the temperature sensor detecting the furnace temperature, for use by the controller 164 to operate the drive assembly 120.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An apparatus for feeding solid fuel feedstock into a furnace comprising:
a conveyor arranged to convey feedstock to a feed zone,
a drive assembly arranged to drive the conveyor, and
a feed member arranged to move between a hold position in which the feedstock is held in the feed zone, and a feed position in which the feed member is configured to feed the feedstock to the furnace;
wherein the drive assembly is arranged to synchronously operate the feed member and the conveyor.

2. The apparatus of claim 1, wherein, when the drive assembly is driven, the drive assembly is configured to move the conveyor continuously.

3. The apparatus of claim 1, wherein when the drive assembly is driven, the drive assembly is configured to move the feed member periodically between the hold position and the feed position.

4. The apparatus of claim 1, wherein the drive assembly comprises a drive member configured to drive the conveyor.

5. (canceled)

6. The apparatus of claim 1, wherein the conveyor comprises conveyor elements configured to act on feedstock elements of the feedstock.

7. The apparatus of claim 1, wherein the drive assembly comprises a feed member actuating assembly arranged to actuate the feed member.

8. The apparatus of claim 1, wherein the drive assembly comprises a cam arrangement arranged to actuate the feed member between the hold position and the feed position.

9. The apparatus of claim 1, wherein the feed member is biased towards the hold position.

10. The apparatus of claim 1, further comprising a counterweight configured to bias the feed member towards the hold position.

11. The apparatus of claim 1, wherein the feed member is arranged to cover a feed opening of a furnace.

12. The apparatus of claim 1, further comprising a feedstock store, wherein the conveyor is arranged to convey the feedstock from the feedstock store to the feed zone.

13. The apparatus of claim 1, further comprising a controller arranged to operate the drive assembly.

14. The apparatus of claim 13, further comprising a temperature sensor.

15. (canceled)

16. (canceled)

17. The apparatus of claim 14, wherein the controller is configured to actuate the drive assembly in dependence on a detected temperature received from the temperature sensor.

18. The apparatus of claim 14, wherein the controller is configured to actuate the drive assembly on receipt of an electrical signal from the temperature sensor, in dependence on the electrical signal indicating a value lower than a threshold value.

19. (canceled)

20. A furnace system comprising the apparatus of claim 1, and a furnace.

21. The furnace system of claim 20, further comprising a feed opening arranged to receive the feedstock, wherein the feed member is arranged to cover the feed opening.

22. A method of delivering solid fuel feedstock into a furnace comprising:
conveying the feedstock to a feed zone,
providing a feed member in a hold position in which the feedstock is held in the feed zone, and
activating the feed member to move from the hold position to a feed position to feed the feedstock into the furnace;
wherein the conveying and activation are synchronously driven by a drive assembly.

23. The method of claim 22, wherein the conveying occurs continuously when the drive assembly is driven.

24. The method of claim 22, wherein activation of the feed member occurs periodically when the drive assembly is driven.
